(19) United States
(12) Patent Application Publication
(10) Pub. No.: US 2008/0048568 A1
(43) Pub. Date: Feb. 28, 2008

(54) Natural light-generating device

(75) Inventors: Chin-Wen Chou, Taipei Hsien (TW); Ying-Nan Cheng, Taipei Hsien (TW); Kuang-Ming Wu, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/510,585

(22) Filed: Aug. 28, 2006

(51) Int. Cl. H05B 37/02

(52) U.S. Cl. 315/159

(57) ABSTRACT

The present invention discloses a natural light-generating device, wherein a light-sensing unit is used to detect the surrounding lighting signals, and a modulated control unit transforms the lighting signals into control signals, and an ultra-low frequency sinusoidal-wave generator performs the permutation and combination of the control signals to sequentially generate driving signals of different timings, frequencies and amplitudes; the driving signals control light-generating elements to simulate the delicate and leisurely variation of the diversified natural daylight; thereby, the windows of the soul can enjoy the gentle and mellow lighting similar to natural daylight; thus, the eyes is massaged, the body and mind relaxed, the health improved, and ocular diseases prevented.

### FIELD OF THE INVENTION

The present invention relates to a natural light-generating device, which utilizes a light-sensing element to detect the surrounding lighting and utilizes an ultra-low frequency sinusoidal-wave generator to control light-generating elements, and the delicate variation of the diversified natural lighting is thus simulated.

### BACKGROUND OF THE INVENTION

It is a well-known nursery rhyme “Eyes clear, eyes bright, body like house, eyes be windows, - - - ”. Eyes are indeed the windows of the soul and are so important to our living and lives. For modern people, eyes are usually overused in working and living. Therefore, some ocular diseases, such as myopia and astigmatism, often occur in modern people.

In a natural environment, lighting shifts with the variation of skyscape and landscape, such as sunlight, clouds, trees and landforms. The delicate variation of natural lighting causes the muscles surrounding eyes to constantly contract and relax, which has an effect of natural massage. However, the people among the concrete jungles of modern cities are hard to enjoy such a nature's grace. Therefore, they often escape from the busy working and living and go to the countryside for relaxation and refreshment.

Those who live in the countryside seldom have myopia or other ocular diseases, and it is mostly the result of the rhythm of natural lighting. However, the lighting in an urban environment is usually fixed and intense, and eyes are constantly under the pressure of expansion, and the ocular health is thus affected. There are various light-adjusting devices in the market, and they are described below.

Refer to FIG. 1 a diagram schematically showing a conventional light-adjusting device for a light bulb. A household incandescent light bulb 51 or an energy-saving lamp 52 emits fixed and intense light, which influences ocular health. Therefore, a fine-tuning switch 1 is used to adjust light intensity. Although the installation of the fine-tuning switches 1 is simple and convenient, they are not widely adopted but usually used in the light bulb 51-like products. The fine-tuning switch 1 will be broken after long-time usage. As the light-adjusting device 1 is operated manually, the user is apt to forget turning it off. Thus, power is persistently supplied to the light bulb 51, which not only consumes energy but also is likely to cause a circuit short.

Refer to FIG. 2 a diagram schematically showing a light-adjusting device for a computer monitor. Computers have been deeply involved in the living of modern people. Many people often watch computer monitors 53 continuously for hours when they work, play games, or write programs/reports. The screen of the computer monitor 53 emits some radiation, which will influence health after a long time exposure. A protective monitor screen filter may be installed to the screen of the computer monitor 53 to reduce radiation. Appropriate rest is also helpful to ocular health. However, controlling the brightness of the computer monitor 53 is further more important for ocular health. As shown in FIG. 2, the common computer monitor 53 has a fine-tuning switch 1 to adjust the brightness thereof. The computer monitor 53 is usually used indoors, and the indoor illumination is almost of the fixed type. The brightness of the computer monitor 53 can be adjusted with the fine-tuning switch 1 to match the indoor illumination. However, the brightness may be insufficient or too much since the fine-tuning switch 1 is operated manually. Thus, the conventional technology may not always insure ocular health.

### SUMMARY OF THE INVENTION

The primary objective of the present invention is to provide a natural light-generating device, which utilizes an ultra-low frequency sinusoidal-wave generator to control light-generating elements and simulates the fine variation of natural lighting.

The natural light-generating device proposed by the present invention utilizes a light-sensing unit to detect the surrounding lighting signals and utilizes a modulated control unit to transform the lighting signals into control signals and utilizes an ultra-low frequency sinusoidal-wave generator to perform permutation and combination to sequentially generate driving signals of different timings, frequencies and amplitudes according to the control signals. The driving signals control light-generating elements to simulate the delicate and leisurely variation of the diversified natural lighting. Thus, the eyes—the windows of the soul—an enjoy the gentle and mellow lighting variation similar to that of natural daylight and can have the ocular massage brought about thereby. Then, the body and mind is relaxed, the health improved, and ocular diseases prevented.

The technical contents and preferred embodiments of the present invention are to be described below in cooperation with drawings.

### BRIEF DESCRIPTION OF THE DRAWINGS

FIG. 1 is a diagram schematically showing a conventional light-adjusting device for a light bulb.

FIG. 2 is a diagram schematically showing a light-adjusting device for a computer monitor.

FIG. 3 is a diagram schematically showing the architecture of the natural light-generating device according to the present invention.

FIG. 4 is a diagram showing the permutation and combination of the ultra-low frequencies of the light source according to the present invention.

FIG. 5 is a diagram schematically showing a first embodiment of the present invention.

FIG. 6 is a diagram schematically showing a second embodiment of the present invention.

FIG. 7 is a diagram schematically showing a third embodiment of the present invention.

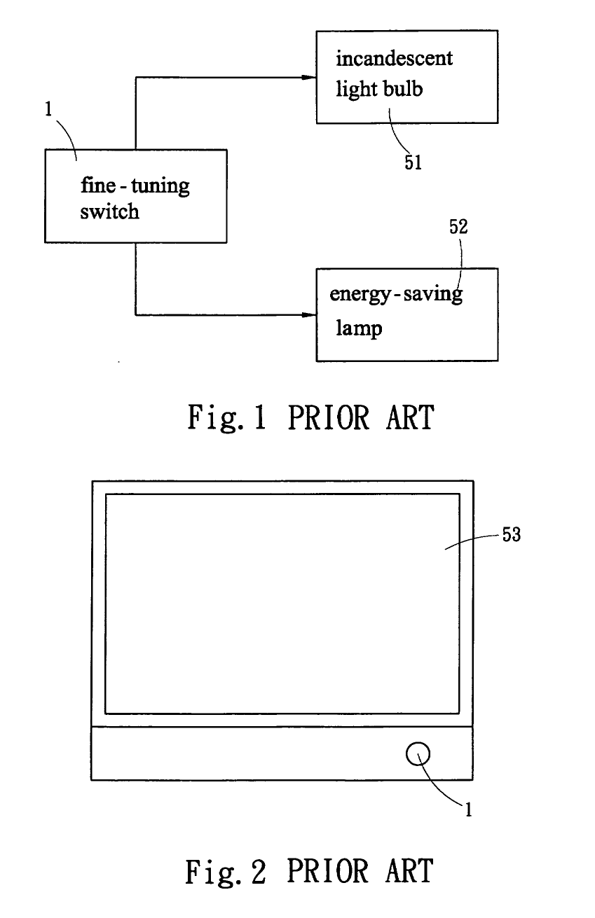

### DETAILED DESCRIPTION OF THE PREFERRED EMBODIMENTS

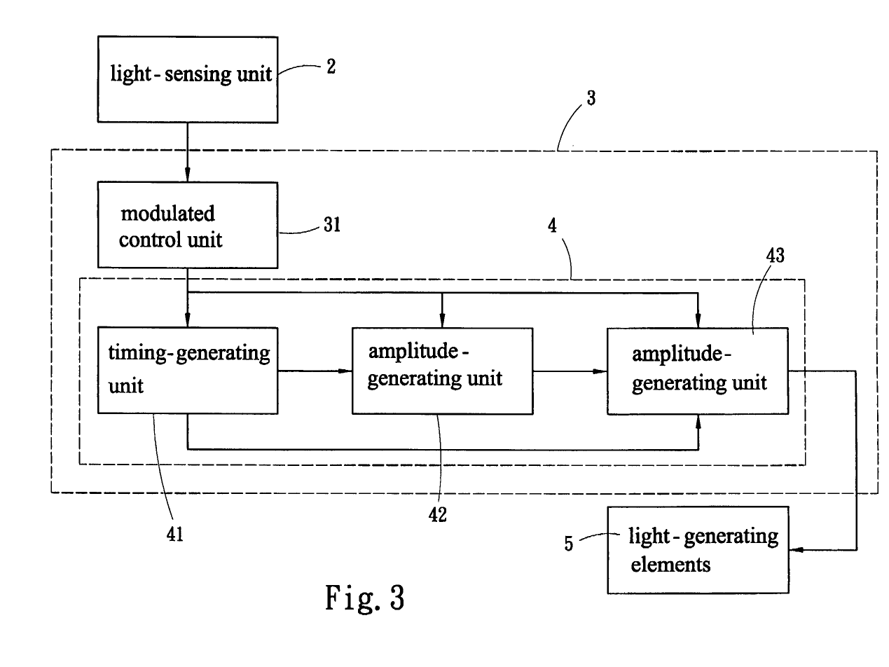

Refer to FIG. 3 a diagram schematically showing the architecture of the natural light-generating device according to the present invention. The natural light-generating device 3 according to the present invention comprises:

a modulated control unit 31, receiving the lighting signals detected by a light-sensing unit 2 and transforming the lighting signals into control signals; and

an ultra-low frequency sinusoidal-wave generator 4, receiving the control signals generated by the modulated control unit 31, having a timing-generating unit 41, a waveform-generating unit 42 and an amplitude-generating unit 43, wherein the ultra-low frequency sinusoidal-wave generator 4 adjusts the light brightness of output devices via one of the following four types of control circuits.

The first type control circuit: the timing-generating unit 41 generates frequencies according to the control signals; next, the waveform-generating unit 42 receives the frequencies and performs the permutation and combination of the frequencies to generate waveforms and outputs to the waveforms to the amplitude-generating unit 43; and then, the amplitude-generating unit 43 utilizes the waveforms to generate amplitudes to control the brightness of light-generating elements 5.

The second type control circuit: the timing-generating unit 41 generates frequencies according to the control signals; the generated frequencies are directly output to the amplitude-generating unit 43; and then, the amplitude-generating unit 43 performs the combination of the generated frequencies to generate amplitudes to control the brightness of the light-generating elements 5.

The third type control circuit: the waveform-generating unit 42 receives the control signals and performs the permutation and combination of the control signals to generate waveforms and outputs the waveforms to the amplitude-generating unit 43; and then, the amplitude-generating unit 43 utilizes the waveforms to generate amplitudes to control the brightness of the light-generating elements 5.

The fourth type control circuit: the amplitude-generating unit 43 directly utilizes the control signals generated by the modulated control unit 31 to generate amplitudes to control the brightness of the light-generating elements 5.

The abovementioned four types of control circuits are used to adjust the light brightness of the light-generating elements 5 and simulate the delicate variation of natural lighting. The parameters of the brightness variation include: the upper brightest point, the mean brightest point and the lower brightest point.

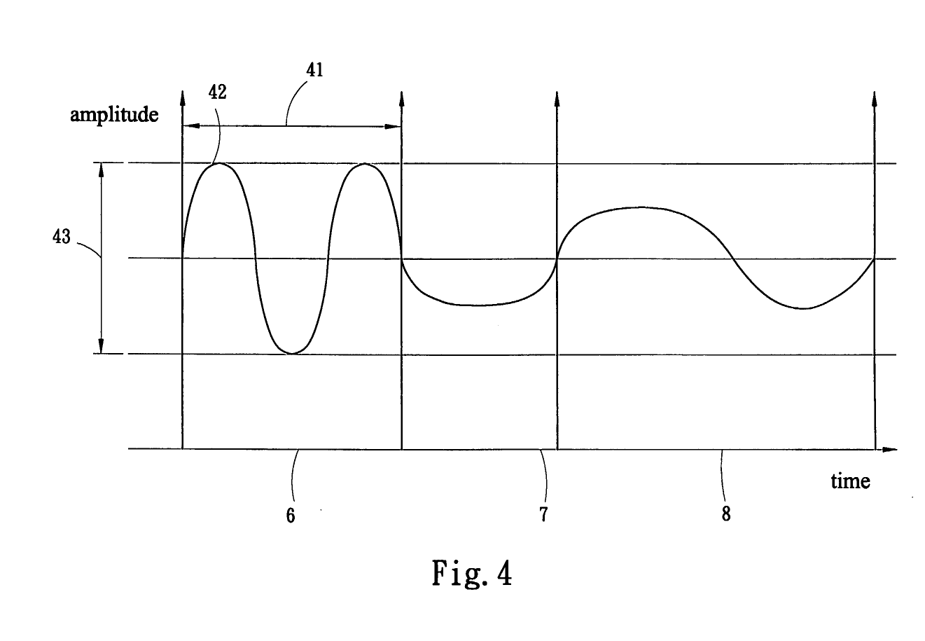

Refer to FIG. 4 a diagram showing the permutation and combination of the ultra-low frequencies of the light source according to the present invention. The ultra-low frequency sinusoidal-wave generator of the present invention can output a first ultra-low frequency section 6, a second ultra-low frequency section 7 and a third ultra-low frequency section 8. For each frequency section, the horizontal axis denotes the time interval determined by the timing-generating unit 41, and the vertical axis denotes the amplitudes generated by the amplitude-generating unit 43, and the waveform-generating unit 42 generates the waveforms formed of the coordinates of the horizontal and vertical axes. The first ultra-low frequency section 6 has multiple sets of frequency ranges respectively arranged inside multiple sets of time intervals according to a specified order. The second ultra-low frequency section 7 has multiple sets of frequency ranges respectively arranged inside multiple sets of time intervals randomly; thus, the time length of the waveform is shorter. The third ultra-low frequency section 8 has one frequency combination arranged randomly inside the time interval between the longest time interval and the shortest time interval, and the time length of the waveform is the longest. From those described above, it is known that the control signals perform the permutation and combination to form the driving signals of different timings, frequencies and amplitudes in different frequency sections. The driving signals formed via the permutation and combination of the abovementioned three types of frequency sections are used to create the gentle and leisurely variation of lighting rhythm to simulate the variation of natural lighting and generate ocular massage.

The natural light-generating device 3 of the present invention not only can incorporates with the signals of the light-sensing unit 2 to adjust the light-source system to obtain the lighting of natural rhythm but also can save energy according to the exterior light brightness. Therefore, the present invention has the function of allocating the brightness of the light-generating elements to match the background lighting. The background-matching lighting-allocation function is to be exemplified below.

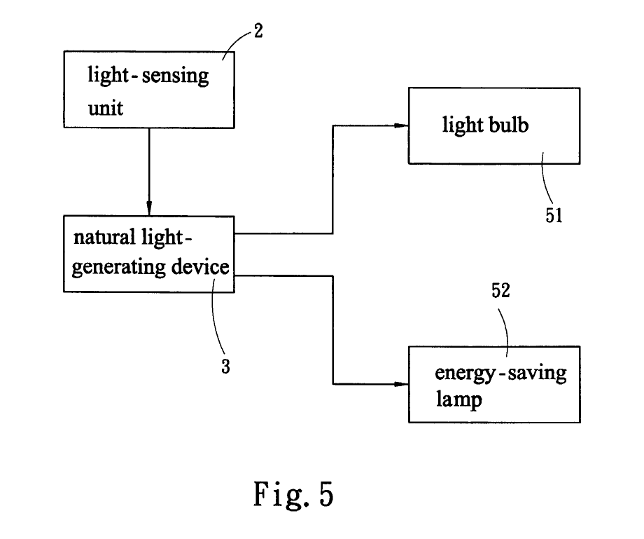

Refer to FIG. 5 a diagram schematically showing a first embodiment of the present invention. There are various inconveniences in manually controlling the light bulb 51-like devices with the conventional fine-tuning switch 1. In the present invention, the background-matching lighting-allocation function is used to control the brightness of light source. Firstly, the light-sensing unit 2 detects lighting signals and inputs the lighting signals to the natural light-generating device 3 to implement the background-matching lighting-allocation function. The permutation and combination of three types of frequency sections is performed to form amplitudes according to the timing waveforms of the brightness of light source, and the amplitudes control output devices. Thereby, the light intensities of the light bulb 51 and the energy-saving lamp 52 are automatically regulated according to the rhythm of the external natural lighting. Thus, not only energy is saved, but also none circuit short will occur.

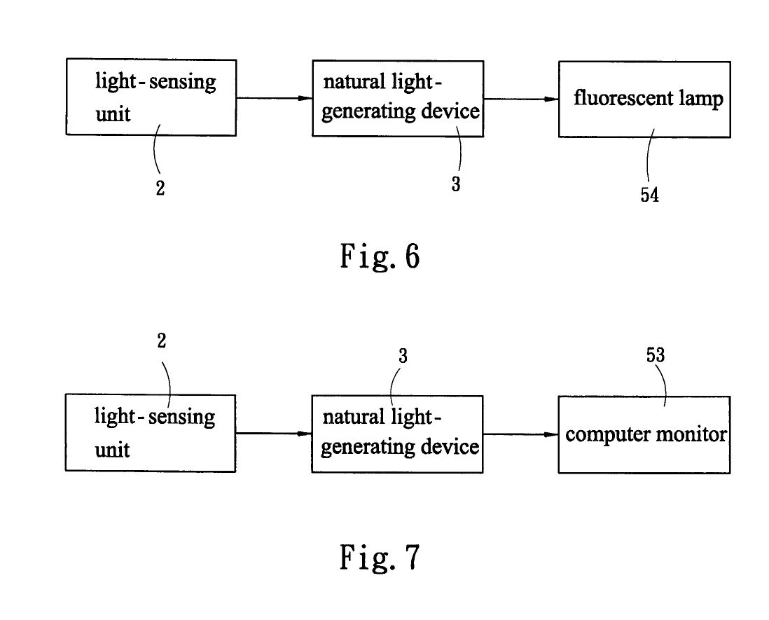

Refer to FIG. 6 a diagram schematically showing a second embodiment of the present invention. Generally, homes, offices and schools use fluorescent lamps 54 as lighting devices. However, the brightness of the fluorescent lamps 54 is incapable of being regulated but fixed and intense, and eyesight will be harmed after a long time stay under such a kind of lighting. In the present invention, the background-matching lighting-allocation function is used to control the light intensities of the fluorescent lamps 54. Similarly, the light-sensing unit 2 detects lighting signals and inputs the lighting signals to the natural light-generating device 3, and the natural light-generating device 3 outputs signals to control the fluorescent lamps 54. Thereby, the light intensities of the fluorescent lamps 54 are automatically regulated according to the brightness of background lighting. The device of the present invention can sense the brightness of background lighting and can simulate the fine variation of the rhythm of natural lighting. Thus, ocular health is protected.

Refer to FIG. 7 a diagram schematically showing a third embodiment of the present invention. Modern people often overuse computers to play games, write programs and so on. Repeated long-time exposure to the computer monitor 53 will harm ocular health. The device of the present invention may also be installed to the computer monitor 53. The light-sensing unit 2 detects the lighting signals of the lighting devices surrounding the computer, and the natural light-generating device 3 appropriately regulates the brightness of the light source of the computer monitor 53 to implement ocular massage. The humanized design of the present invention protects ocular health. Further, the gentle and leisurely variation of the rhythm of the light source, which is implemented by the background-matching lighting-allocation function, can also achieve energy efficiency.

Those described above are the preferred embodiments to exemplify the present invention. However, it is not intended to limit the scope of the present invention. Any equivalent modification and variation according to the spirit of the present invention is to be also included within the scope of the present invention.

What is claimed is:

1. A natural light-generating device, utilizing a light-sensing unit to detect the signals of the surrounding lighting intensities to regulate the light brightness of light-generating elements, and comprising:
a modulated control unit, transforming said signals detected by said light-sensing unit into control signals; and
an ultra-low frequency sinusoidal-wave generator, receiving said control signals generated by said modulated control unit, and according to said control signals, generating driving signals, which include: timings, frequencies and amplitudes, to drive said light-generating elements.

2. The natural light-generating device according to claim 1, wherein said modulated control unit is an modulated control device.

3. The natural light-generating device according to claim 1, wherein said ultra-low frequency sinusoidal-wave generator further comprises: a timing-generating unit, a waveform-generating unit and an amplitude-generating unit.

4. The natural light-generating device according to claim 1, wherein said ultra-low frequency sinusoidal-wave generator is used to regulate the brightness of output light.

5. The natural light-generating device according to claim 4, wherein the parameters of said brightness variation include: an upper brightest point, a mean brightest point and a lower brightest point.

6. The natural light-generating device according to claim 4, wherein said brightness variation is a gentle and leisurely variation of the rhythm of a lighting source, and the sinusoidal waveforms thereof may vary according to the demand for a specified effect.

7. The natural light-generating device according to claim 1, wherein said driving signals are formed via performing the permutation and combination of multiple sets of ultra-low frequencies.
